(19) United States
(12) Patent Application Publication
(10) Pub. No.: US 2005/0205758 A1
(43) Pub. Date: Sep. 22, 2005

(54) Method and apparatus for multi-spectral photodetection

(76) Inventor: Leo A. Almeida, Alexandria, VA (US)

Correspondence Address: DEPARTMENT OF THE ARMY, AMSEL LG P NVEO, 10225 BURBECK ROAD, FORT BELVOIR, VA, 22060-5806, US

(21) Appl. No.: 10/804,005

(22) Filed: Mar. 19, 2004

(51) Int. Cl. G01J 1/42; H01J 5/16

(52) U.S. Cl. 250/208.2; 250/226

(57) ABSTRACT

A multispectral photodetector array includes a two-dimensional array of photodetectors, either photodiodes or photoconductors, are coupled to a read out integrated circuit. The integrated circuit collects electrical signals from individual pixels of the array. Such an array differs from a conventional array in that each row or group of rows in the array has a distinct spectral response.

### GOVERNMENT INTEREST

The invention described herein may be manufactured, used, sold, imported, and/or licensed by or for the Government of the United States of America.

### FIELD OF INTEREST

This invention relates to an array of photodetectors consisting of rows or groups with distinct spectral responses.

### BACKGROUND OF THE INVENTION

Conventional spectrometers utilize diffraction gratings or similar elements to disperse a light signal. The diffraction grating can be moved or scanned such that the dispersed light signal is incident on a single photo detector. The detector is chosen so that its spectral response is matched to that of the incoming radiation and of the grating. As the diffraction grating is moved in a step-wise fashion, distinct wave bands of light are detected and a spectrum of the incident light intensity is generated as a function of time. Alternatively, linear array of photo detectors, all of which have identical photoresponse, can be placed in the path of a dispersed light signal from a fixed diffraction grating. However, these prior art device cannot process temporal, spatial and spectroscopic data simultaneously.

Accordingly, there is a need to have a temporal, spatial and spectroscopic data simultaneously. The present invention addresses this need.

### SUMMARY OF THE INVENTION

Accordingly, one object of the present invention is to provide a multi spectral photodetector that provides temporal, spatial and spectroscopic data simultaneously.

This and other objects of the present invention are achieved by providing for a multispectral focal plane array which includes an array of photodetectors having individual photodetectors which have a distinct spectral response; and an integrated circuit coupled to the array, wherein the integrated circuit collects electrical signals from the individual photodetectors. The photodetectors are fabricated from ternary or quaternary compound semiconducting materials whose band-gap varies via a grading of the chemical composition of the photodetector. The grading of the semiconducting material and the varying height of the photodetectors determine the distinct spectral response of the photodetectors.

The photodetector array according to the present invention acquires temporal, spatial and spectroscopic data simultaneously. This eliminates the need for dispersive optical elements when used either in a spectrometer (see FIG. 1b) or spectral imager (see FIG. 2b). The elimination of dispersive optical elements leads to a higher light throughput for optical systems.

### BRIEF DESCRIPTION OF THE DRAWINGS

These and other objects of the invention will become readily apparent in light of the Detailed Description of the Preferred Embodiment and the attached drawings wherein:

FIGS. 1a and b are schematic representations of a photodetector arrays. FIG. 1a is a representation of a conventional linear photodetector array. FIG. 1b is a representation of a linear multispectral photodetector array according to the present invention.

FIGS. 2a and b are schematic representations of a hyperspectral imaging application using 2 dimensional multispectral photodetector arrays. FIG. 2a shows a conventional 2-dimensional photodetector array used in the hyperspectral imager and FIG. 2b is a representation of a two-dimensional multispectral photodetector array according to the present invention

FIGS. 3a-3c show the epitaxy and photolift steps to form an epitaxial layer of a compound semiconducting material that is the basis of the multi-spectral photodetector array according to the present invention.

### DETAILED DESCRIPTION OF THE PREFERRED EMBODIMENT

The multi-spectral imager/spectrometer according to the present invention includes a two-dimensional array of photodetectors, which detect photons (light) and generate electric signals proportional to the flux of incident photons. This array is coupled to an integrated circuit, which collects electrical signals from the individual pixels. Furthermore, in this array any given row or group of rows is preferentially sensitive to distinct wavebands (colors) of light. Using this array, light can be spectrally analyzed without the use of a diffraction grating or similar dispersive optical element. Additionally, this array may be utilized as a scanning focal plane array to image a scene in multiple wave bands (hyperspectral imager). Depending on the compound semiconducting material system used to fabricate the multi-spectral imager/spectrometer, a wide variety of wavelengths of light may be analyzed from long wavelength (12 μm)infrared (using HgCdTe to ultraviolet (using AlGaN).

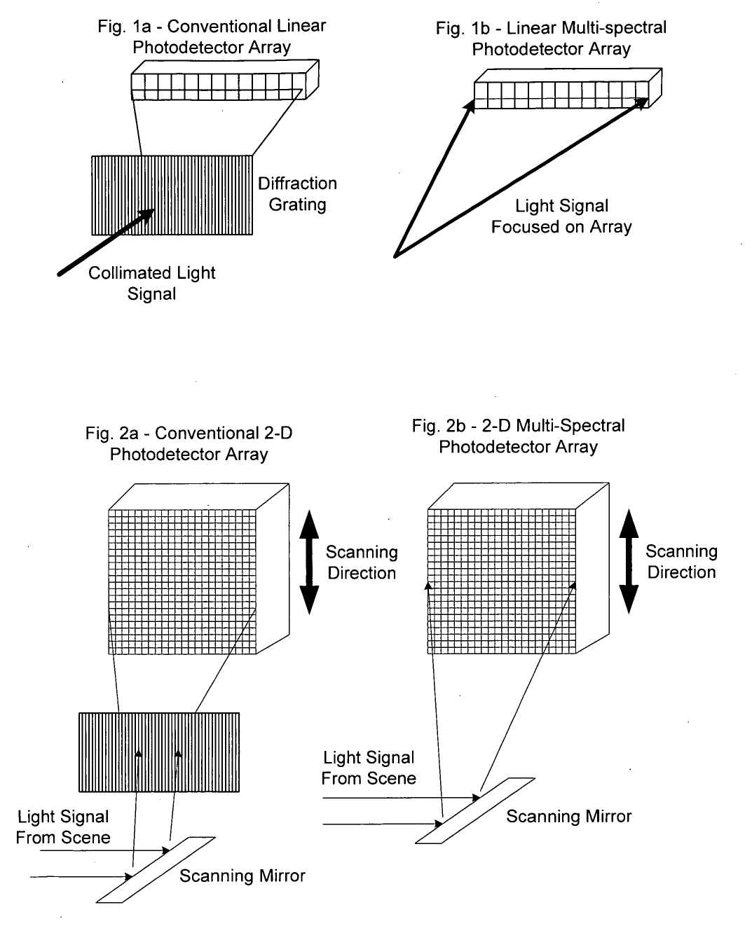

FIG. 1b is a representation of a linear multispectral photodetector array according to the present invention. The multispectral photodetector array includes a two-dimensional array of photodetectors, either photodiodes or photoconductors, coupled to a read out integrated circuit, whose function is to collect electrical signals from individual pixels. Such an array differs from a conventional array in that each row or group of rows in the array has a distinct spectral response. The size of the array is arbitrary and may be chosen to suit the needs of specific applications. The upper size limit is dictated primarily by that area of suitable semiconducting material that is available, as well as limitations imposed by conventional semiconductor device processing methods.

In the present invention, the signal from each individual pixel of the linear array corresponds to a distinct spectral response. According to the present invention, each pixel has a broadband response and it is the cut-off of the broadband response that varies across the array. Because there are no moving parts, this configuration provides faster data acquisition and a more mechanically robust system.

In order to generate a spectral image of a scene (i.e. simultaneously acquire spectral and spatial data), a two-dimensional array of such photo detectors is placed in the path of a dispersed light signal from a fixed diffraction grating such that each row of pixels detects a distinct waveband. Such a system is pictured schematically in FIGS. 2b. A mirror is moved in a step-wise fashion to scan the scene and generate spatial information. For one complete cycle of the mirror's motion, corresponding to one scan line of the scene, the signals from each column generate spatial data.

A diffraction grating or a similar dispersive optical element is necessary for conventional spectrometers and spectral imagers. The design and construction of optical elements; particular care must be taken to align such elements. Furthermore, the use of diffraction gratings leads to a loss of light intensity due to higher order diffraction bands.

The multispectral photodetector array derives its functionality from the inherent opto-electrical properties of ternary and quaternary compound semiconducting materials. Its fabrication is facilitated by advanced epitaxial technology (band gap engineering), which allows precise control over the thickness and chemical composition of deposited compound semiconductors. Semiconducting material absorbs photons with energies greater than a certain energy, which is a characteristic of a given material; this characteristic energy is known as the band gap energy. The material is transparent to photons with energies less than the band gap energy. Furthermore, for a ternary (or quaternary) compound semiconducting material system, such as Hg₁₋ₓCdₓTe, the band gap varies with chemical composition (x value). Therefore, by changing the chemical composition of a material in a deliberate manner, one can control the band gap and therefore, the spectral response of the material.

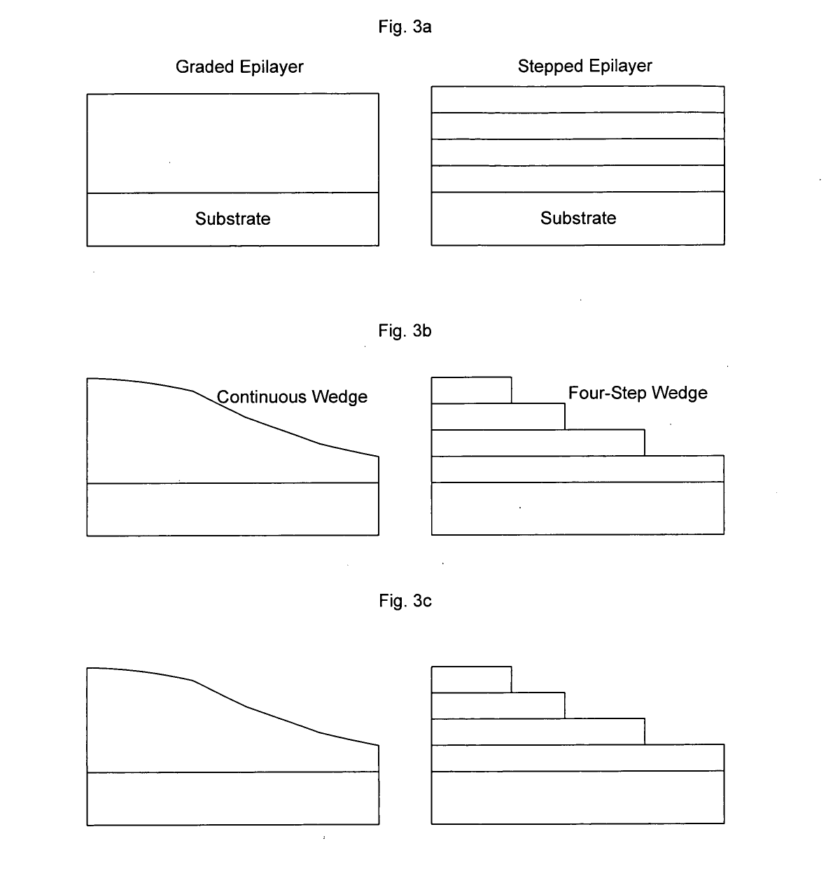

The basis of the multi-spectral photodetector array is an epitaxial layer of a compound semiconducting material, whose composition varies in the direction of growth in either a graded or stepped fashion (FIG. 3a Step 1). A continuously graded composition of the epilayer is required for a multi-spectral photodetector array with each row corresponding to a distinct spectral response (FIG. 3a). A stepped compositional profile in the epilayer is required for a multi-spectral photodetector array with groups of rows corresponding to distinct spectral response (right FIG. 3b). The number of compositional steps in the epilayer determines the number of groups of rows with distinct spectral responses. For a backside illuminated configuration, the composition is graded such that material with the largest bandgap is deposited first and subsequently smaller bandgap material is deposited. Once the epilayer is deposited, it is then processed using standard photolithographic techniques.

The first and most crucial of the device processing steps entails creating a wedge or stepped wedge shape across the entire area of the focal plane array (FIG. 3b). The direction of the wedge determines the orientation of the rows and columns. For example, in the cross-sectional diagram of FIG. 3b, rows of detectors will be oriented perpendicular to the plane of the page, while columns will be parallel to the plane of the page, running horizontally. Once the wedge is created and orientation of the rows and columns is determined, standard semiconductor processing steps are used to delineate individual photodetectors.

Spectral information from the array is compiled based on the fact that progressively longer wavelengths of light will be absorbed in consecutive rows containing material with smaller band gaps. In FIGS. 3a and b, pixels (or rows of pixels) toward the left hand side of the Figure absorb longer wavelengths of light. Additionally, any given pixel absorbs virtually all of the light absorbed by its neighboring pixel to the right. Therefore, the difference in signals between consecutive rows provides spectral information.

1. A multispectral focal plane array comprising:
a linear array of photodetectors, each photodetector in the linear array having a distinct spectral response; and
an integrated circuit coupled to a read out of the linear array, wherein the integrated circuit collects electrical signals from the individual photodetectors.

2. A multispectral focal plane array comprising:
a two-dimensional array of photodetectors having groups of photodetectors, each group having a distinct spectral response; and
an integrated circuit coupled to a read out of the two-dimensional array, wherein the integrated circuit collects electrical signals from the photodetectors.

3. The multispectral focal plane array of claim 1 wherein the photodetectors are, either photodiodes or photoconductors.

4. The multispectral focal plane array of claim 2 wherein the photodetectors are, either photodiodes or photoconductors.

5. The multispectral focal plane array of claim 1 wherein the photodetectors are fabricated from epilayers of ternary or quaternary compound semiconducting materials whose band-gap varies via a grading of the chemical composition of the photodetector.

6. The multispectral focal plane array of claim 2 wherein the photodetectors are fabricated from ternary or quaternary compound semiconducting materials whose band-gap varies through a grading of the chemical composition of the photodetector.

7. The multispectral focal plane array of claim 1 wherein the photodetectors vary in height and are fabricated from epilayers of compositionally graded compound semiconducting material such that the height of the photodetector determines the distinct spectral response of photodetector.

8. The multispectral focal plane array of claim 2 wherein the photodetectors vary in height and are fabricated from epilayers of compositionally graded compound semiconducting material such that the height of the photodetector determines the distinct spectral response of photodetector.

9. The multispectral focal plane array of claim 7 wherein any photodetector of a given height is a broadband detector which detects more long-wavelength photons than those photodetectors which are shorter and fewer long-wavelength photons than those photodetectors which are taller.

10. The multispectral focal plane array of claim 8 wherein any group of photodetectors of a given height are broadband detectors which detect more long-wavelength photons than those groups of photodetectors which are shorter and fewer long-wavelength photons than those groups of photodetectors which are taller.

11. The multispectral focal plane array of claim 1 wherein the photodetector array is formed of rows of photodetectors each of a distinct height, fabricated from a continuously graded epilayer of compound semiconductor, wherein each row of the two-dimensional array corresponds to a distinct spectral response.

12. The multispectral focal plane array of claim 2 wherein the photodetector array is formed of groups of rows of photodetectors, wherein each group is a distinct height, fabricated from a step-wise graded epilayer of compound semiconductor, wherein each group of rows of the two-dimensional array corresponds to a distinct spectral response.

13. The multispectral focal plane array of claim 1 wherein the photodetector array is a continuously graded epilayer formed of rows of pixels, wherein each row of the two-dimensional array corresponds to a distinct spectral response.

14. The multispectral focal plane array of claim 2 wherein the photodetector array is a continuously graded epilayer formed of rows of pixels, wherein each row of the two-dimensional array corresponds to a distinct spectral response.

15. The multispectral photodetector array of claim 11 wherein the ternary or quaternary compound semiconducting material system is formed of Hg₁₋ₓCdₓTe, wherein the band gap of Hg₁₋ₓCdₓTe varies with chemical composition (x value).

16. The multispectral photodetector array of claim 12 wherein the ternary or quaternary compound semiconducting material system is formed of Hg₁₋ₓCdₓTe, wherein the band gap of Hg₁₋ₓCdₓTe varies with chemical composition (x value).
